(19) United States
(12) Patent Application Publication
(10) Pub. No.: US 2015/0268195 A1
(43) Pub. Date: Sep. 24, 2015

(54) SENSOR DEVICE AND METHOD OF OPERATING THEREOF

(71) Applicant: Agency for Science, Technology and Research, Singapore (SG)

(72) Inventors: Patthara Kongsuphol, Singapore (SG); Sunil Kumar Arya, Singapore (SG); Qing Liu, Singapore (SG); Mi Kyoung Park, Singapore (SG)

(21) Appl. No.: 14/664,606

(22) Filed: Mar. 20, 2015

(30) Foreign Application Priority Data
Mar. 20, 2014 (SG) 10201400801U

(51) Int. Cl. G01N 27/447

(52) U.S. Cl. CPC G01N 27/44791; G01N 27/44756

(57) ABSTRACT

According to various embodiments, there is provided a sensor device including a separation reservoir configured to contain a plurality of target molecules; a first electric field generator configured to provide a first electric field across the separation reservoir, the first electric field having a first direction; a second electric field generator configured to provide a second electric field across the separation reservoir, the second electric field having a second direction, wherein the second direction is at least substantially perpendicular to the first direction; and a plurality of sensing elements arranged on a side of the separation reservoir, wherein each sensing element of the plurality of sensing elements is configured to detect target molecules within a vicinity of the respective sensing element.

### CROSS-REFERENCE TO RELATED APPLICATIONS

This application claims benefit of Singapore Patent Application number 102014008010 filed 20 Mar. 2014, which is incorporated in its entirety herein by reference.

### TECHNICAL FIELD

The present invention relates to sensor devices and methods of operating sensor devices.

### BACKGROUND

Sensor technology, such as biosensor technology, is a fast expanding field which benefits a number of industries, including biomedical research, the health care industry, the food industry, environmental care, and homeland security. For health care industries such as the pharmaceutical industry and the biomedical industry, point-of-care (POC) application has recently gained much attention. POC applications may be applied directly at the bedside of a patient or near the site of patient care, with simple operating procedures. Further, the results of POC testing may be obtained within a brief period of time. A desirable POC application is the detection of signals from samples collected from a patient at the bedside, such samples including blood or serum. However, it is challenging for biosensors to handle blood or serum samples, because blood and serum contain a high background content of proteins, electrolytes, lipids, organic substances, etc. which may interfere with target signals and possibly give rise to false positive signals.

A biosensor may be used to diagnose diseases. In many cases, a diagnosis may require detection of several biomarkers. Therefore, a biosensor should preferably be able to provide multiplexing results. While multiplexing bioassays have been developed, background interference is still an issue in these assays in which low sensitivity is observed when processing blood or serum samples.

Electrophoresis is a common laboratory technique used to separate bio-molecules, including nucleic acids and proteins, based on their molecule sizes and/or charges. After separation of the bio-molecules, a labeling method is employed to spot and detect the presence of the target molecules. For protein detection, in a process known as the western blot, proteins must be transferred to a membrane before multiple immuno-labeling steps can be carried out making the whole process a tedious and time consuming process. Nevertheless, this technique gives high signal specificity because only the signal detected from a desired molecular weight is selectively considered as a positive signal regardless of signals that appear at the different locations.

Enzyme-linked immunosorbent assay (ELISA) is a laboratory technique employed to detect the interested proteins and their activities by utilizing multiple labeling steps of matching antibodies to their specific antigens. Similar to the western blot, the whole process of ELISA is a tedious and a time consuming process due to the multiple labeling steps. The signal specificity depends entirely on the ability of antibodies to specifically bind to the target molecules and if the antibodies have low specificities towards the target molecules, the chances of false positive signal detection may be extremely high. Therefore in the usage of ELISA, efficient prevention of non specific binding is required to reduce the effect of background interference. A common method employed to prevent the non specific binding is a blocking method where the sensing matrix is pre-exposed to a blocking agent in order for the blocking agent to fill up the non sensing area within the sensing matrix thereby preventing interaction of non specific molecules with the sensing matrix. However, the blocking agent and the labeling probes themselves may also cause non specific binding, thereby reducing the detection sensitivity and increasing the chances of false positive signal detections.

Techniques such as the western blot and the ELISA may not be suitable for POC applications because they require complex imaging systems for signal detection and they are not able to provide multiplexing results. The x-MAP technology developed by Luminex is able to perform multiplex signal detection, by utilizing different ratios of two loading dyes loaded into micro-beads to give each population of micro-beads a unique identity in which each population of the micro-beads is tagged with a different type of probes/antibodies. Once the micro-beads are bound to the target molecules, a laser machine is used to identify different population of micro-beads and signals produced from probes-target molecules interactions therefore allowing a large number of multiplexing. Although this technology is able to run large number of multiplexing, background interference is only addressed through blocking. In addition, the xMAP technology requires multiple labeling steps and complex laser imaging system, which renders it unsuitable for POC applications.

Biosensors may employ electrochemical or biophotonic sensors for detection of signals from blood or serum samples. The sensing mechanism may be based on interaction of probes such as antibodies or aptamer, with the target molecules. The effect of background interference may be reduced through blocking method. However, these biosensors only offer a low number of multiplexing.

Western blot is an efficient technique to detect specific signal with lesser background interference, and therefore may be imported onto a micro-system for biosensor development. Microfluidic western blot platforms may separate proteins using electrophoresis and immobilize the proteins onto the microfluidic wall using UV-light or transfer the proteins onto a polyvinylidene fluoride membrane using electrical signal. For signal detection, multiple immuno-labeling steps are applied through the microfluidic channel to mark the target molecules and, in a similar fashion performed in the conventional western blot, photonic methods may be employed to detect the signals.

While there are other types of microfluidic electrophoresis devices, these devices focused on the separation technique. A microfluidic device may be equipped with multiple pairs of electrodes along a channel wall in which low voltage is applied to each pair of electrodes to drive the bio-molecule separation through the microfluidic channel. A microfluidic device may include a capillary electrophoresis-electrochemical detection device in which a cross-shaped micro-capillary channel is designed for separating and detecting the target molecules. A sample may be loaded into one end of the channel and the separation may be conducted by applying a negative voltage to the opposite end of the loading channel. Signals may be detected using an electrochemical sensor which is placed at the channel-end opposite to the loading-end. Positive voltage may be applied to the detection end to attract the separated molecules to the detection pad. Based on this technique each population of similar size molecules are being detected one at a time, starting from smaller to larger molecule sizes. However, none of the available sensor devices are able to achieve multiplexing signal detection and low background interference, while being suitable for POC applications.

### SUMMARY

According to various embodiments, there may be provided a sensor device including a separation reservoir configured to contain a plurality of target molecules; a first electric field generator configured to provide a first electric field across the separation reservoir, the first electric field having a first direction; a second electric field generator configured to provide a second electric field across the separation reservoir, the second electric field having a second direction, wherein the second direction is at least substantially perpendicular to the first direction; and a plurality of sensing elements arranged on a side of the separation reservoir, wherein each sensing element of the plurality of sensing elements is configured to detect target molecules within a vicinity of the respective sensing element.

According to various embodiments, there may be provided a method of operating a sensor device, the method including providing a separation reservoir, the separation reservoir configured to contain a plurality of target molecules; providing a first electric field across the separation reservoir using a first electric field generator, wherein the first electric field has a first direction; providing a second electric field across the separation reservoir using a second electric field generator, wherein the second electric field has a second direction, wherein the second direction is at least substantially perpendicular to the first direction; providing a plurality of sensing elements arranged on a side of the separation reservoir; and detecting target molecules within a vicinity of each sensing element of the plurality of sensing elements.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a conceptual diagram of a sensor device in accordance to various embodiments.

FIG. 2 shows a conceptual diagram of a sensor device in accordance to various embodiments.

FIG. 3 shows a flow diagram of a method of operating a sensor device, in accordance to various embodiments.

FIGS. 4A to 4D show a method of operating a sensor device in accordance to various embodiments.

FIG. 5 shows a perspective view of a sensor device in accordance to various embodiments.

FIG. 6 shows a perspective view of the sensor device of FIG. 5.

FIG. 7 shows an enlarged view of the sensor device of FIG. 5.

FIG. 8 shows a top view of a sensor device in accordance to various embodiments.

FIG. 9 shows a top view of a sensor device in accordance to various embodiments.

FIG. 10 shows a cross-sectional view across a channel of a sensor device in accordance to various embodiments.

FIG. 11 shows a cross-sectional view across a channel of the sensor device of FIG. 10.

FIGS. 12A to 12B show cross-sectional views across a channel of a sensor device in accordance to various embodiments.

FIG. 13 shows a plurality of proteins separated for use in an experiment.

FIG. 14A shows a schematic diagram of an experiment set-up.

FIG. 14B shows a top view of an electrochemical sensor used in the test set-up of FIG. 14A.

FIG. 15 shows a graph of impedance values plotted for a plurality of samples used in an experiment.

FIG. 16 shows a graph of normalized charge transfer values plotted against a volume of protein.

FIG. 17A shows a schematic diagram of a test set-up used in an experiment.

FIG. 17B shows a conceptual diagram of a biophotonic chip used in an experiment.

FIG. 17C shows a microscope image of the biophotonic chip of FIG. 17B.

FIG. 17D shows a perspective view of the biophotonic chip of FIG. 17B.

FIG. 18 shows a graph of power plotted against a wavelength of light incident on a plurality of samples.

FIG. 19 shows a bar chart presenting the peak shifts in the refractive indices of three different samples.

FIG. 20 shows a microchannel device used for an experiment.

FIG. 21 shows a bar chart presenting the optical densities of two different samples.

FIG. 22 shows a bar chart presenting the relative optical densities of two different samples.

FIG. 23 shows a graph of charge transfer values plotted against a protein concentration.

### DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

In this context, a sensor device may be a biosensor device. A sensor device may be applied in medical or pharmaceutical applications, as well as other non-medical applications.

In this context, the sensor device as described in this description may include a memory which is for example used in the processing carried out in the sensor device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

Sensor technology, such as biosensor technology, is a fast expanding field which benefits a number of industries, including biomedical research, the health care industry, the food industry, environmental care, and homeland security. For health care industries such as the pharmaceutical industry and the biomedical industry, point-of-care (POC) application has recently gained much attention. POC applications may be applied directly at the bedside of a patient or near the site of patient care, with simple operating procedures. Further, the results of POC testing may be obtained within a brief period of time. A desirable POC application is the detection of signals from samples collected from a patient at the bedside, such samples including blood or serum. However, it is challenging for biosensors to handle blood or serum samples, because blood and serum contain a high background content of proteins, electrolytes, lipids, organic substances, etc. which may interfere with target signals and possibly give rise to false positive signals.

A biosensor may be used to diagnose diseases. In many cases, a diagnosis may require detection of several biomarkers. Therefore, a biosensor should preferably be able to provide multiplexing results. While multiplexing bioassays have been developed, background interference is still an issue in these assays in which low sensitivity is observed when processing blood or serum samples.

Electrophoresis is a common laboratory technique used to separate bio-molecules, including nucleic acids and proteins, based on their molecule sizes and/or charges. After separation of the bio-molecules, a labeling method is employed to spot and detect the presence of the target molecules. For protein detection, in a process known as the western blot, proteins must be transferred to a membrane before multiple immuno-labeling steps can be carried out making the whole process a tedious and time consuming process. Nevertheless, this technique gives high signal specificity because only the signal detected from a desired molecular weight is selectively considered as a positive signal regardless of signals that appear at the different locations.

Enzyme-linked immunosorbent assay (ELISA) is a laboratory technique employed to detect the interested proteins and their activities by utilizing multiple labeling steps of matching antibodies to their specific antigens. Similar to the western blot, the whole process of ELISA is a tedious and a time consuming process due to the multiple labeling steps. The signal specificity depends entirely on the ability of antibodies to specifically bind to the target molecules and if the antibodies have low specificities towards the target molecules, the chances of false positive signal detection may be extremely high. Therefore in the usage of ELISA, efficient prevention of non specific binding is required to reduce the effect of background interference. A common method employed to prevent the non specific binding is a blocking method where the sensing matrix is pre-exposed to a blocking agent in order for the blocking agent to fill up the non sensing area within the sensing matrix thereby preventing interaction of non specific molecules with the sensing matrix. However, the blocking agent and the labeling probes themselves may also cause non specific binding, thereby reducing the detection sensitivity and increasing the chances of false positive signal detections.

Techniques such as the western blot and the ELISA may not be suitable for POC applications because they require complex imaging systems for signal detection and they are not able to provide multiplexing results. The x-MAP technology developed by Luminex is able to perform multiplex signal detection, by utilizing different ratios of two loading dyes loaded into micro-beads to give each population of micro-beads a unique identity in which each population of the micro-beads is tagged with a different type of probes/antibodies. Once the micro-beads are bound to the target molecules, a laser machine is used to identify different population of micro-beads and signals produced from probes-target molecules interactions therefore allowing a large number of multiplexing. Although this technology is able to run large number of multiplexing, background interference is only addressed through blocking. In addition, the xMAP technology requires multiple labeling steps and complex laser imaging system, which renders it unsuitable for POC applications.

Biosensors may employ electrochemical or biophotonic sensors for detection of signals from blood or serum samples. The sensing mechanism may be based on interaction of probes such as antibodies or aptamer, with the target molecules. The effect of background interference may be reduced through blocking method. However, these biosensors only offer a low number of multiplexing.

Western blot is an efficient technique to detect specific signal with lesser background interference, and therefore may be imported onto a micro-system for biosensor development. Microfluidic western blot platforms may separate proteins using electrophoresis and immobilize the proteins onto the microfluidic wall using UV-light or transfer the proteins onto a polyvinylidene fluoride membrane using electrical signal. For signal detection, multiple immuno-labeling steps are applied through the microfluidic channel to mark the target molecules and, in a similar fashion performed in the conventional western blot, photonic methods may be employed to detect the signals.

While there are other types of microfluidic electrophoresis devices, these devices focused on the separation technique. A microfluidic device may be equipped with multiple pairs of electrodes along a channel wall in which low voltage is applied to each pair of electrodes to drive the bio-molecule separation through the microfluidic channel. A microfluidic device may include a capillary electrophoresis-electrochemical detection device in which a cross-shaped micro-capillary channel is designed for separating and detecting the target molecules. A sample may be loaded into one end of the channel and the separation may be conducted by applying a negative voltage to the opposite end of the loading channel. Signals may be detected using an electrochemical sensor which is placed at the channel-end opposite to the loading-end. Positive voltage may be applied to the detection end to attract the separated molecules to the detection pad. Based on this technique each population of similar size molecules are being detected one at a time, starting from smaller to larger molecule sizes. However, none of the available sensor devices are able to achieve multiplexing signal detection and low background interference, while being suitable for POC applications.

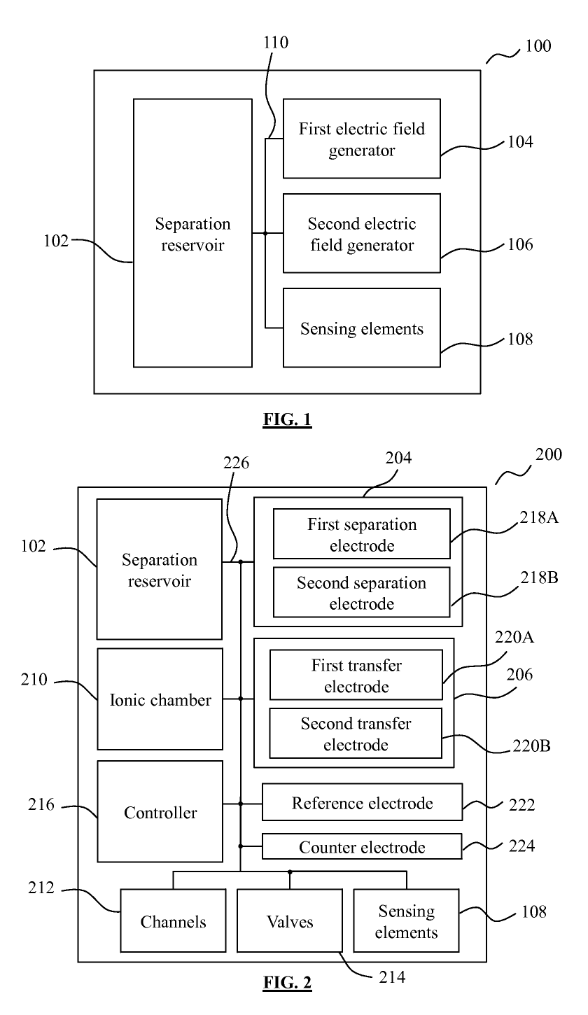

FIG. 1 shows a sensor device 100 according to various embodiments. The sensor device 100 may include a separation reservoir 102, a first electric field generator 104, a second electric field generator 106 and a plurality of sensing elements 108. The separation reservoir 102 may be configured to contain a plurality of target molecules. The first electric field generator 104 may be configured to provide a first electric field across the separation reservoir 102. The first electric field may have a first direction. The second electric field generator 106 may be configured to provide a second electric field across the separation reservoir 102. The second electric field may have a second direction. The second direction may be at least substantially perpendicular to the first direction. The plurality of sensing elements 108 may be arranged on a side of the separation reservoir 102. Each sensing element 108 of the plurality of sensing elements 108 may be configured to detect target molecules within a vicinity of the respective sensing element 108. The separation reservoir 102, the first electric field generator 104, the second electric field generator 106 and the plurality of sensing elements 108 may be connected to each other via a connection 110. The connection 110 may be at least one of a mechanical or an electrical connection.

In other words, according to various embodiments, the sensor device 100 may include a separation reservoir 102 configured to hold a plurality of target molecules, a first electric field generator 104 configured to provide a first electric field across the separation reservoir 102, a second electric field generator 106 configured to provide a second electric field across the separation reservoir 102 and a plurality of sensing elements 108 arranged on a side of the separation reservoir 102. The first electric field may have a first direction and the second electric field may have a second direction which is at least substantially perpendicular to the first direction. Each sensing element 108 of the plurality of sensing elements 108 may be configured to detect target molecules within a vicinity of the respective sensing element 108.

The sensor device 100 may include a separation reservoir 102, a first electric field generator 104, a second electric field generator 106 and a plurality of sensing elements 108. The separation reservoir 102 may be configured for holding a separation matrix. The separation matrix may be a gel matrix. A sample containing a plurality of target molecules may be loaded into the separation matrix. The first electric field generator 104 may be configured to provide a first electric field which has a first direction, across a length of the separation reservoir 102. The first electric field may be configured to separate the plurality of target molecules within the separation matrix. The second electric field generator 106 may be configured to provide a second electric field which has a second direction, across a width of the separation reservoir 102. The second direction may be at least substantially perpendicular to the first direction. The second electric field may be configured to move the plurality of target molecules towards the plurality of sensing elements 108. The plurality of sensing elements 108 may be arranged on a side of the separation reservoir 102. The plurality of sensing elements 108 may be detachable from the sensor device 100. Each sensing element 108 within the plurality of sensing elements 108 may be configured to detect target molecules within a vicinity of the respective sensing element 108. The plurality of sensing elements 108 may be electrochemical sensors. The plurality of sensing elements 108 may be optical sensors such as biophotonic sensors. The entire sensor device 100 may be configured as a microfluidic chip.

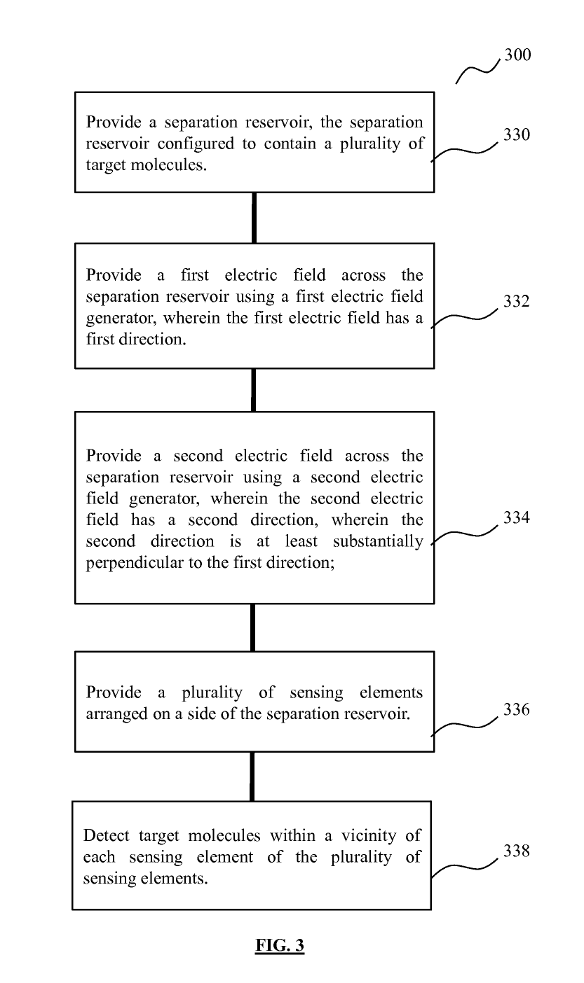

FIG. 2 shows a sensor device 200 in accordance to various embodiments. The sensor device 200, similar to the sensor device 100 of FIG. 1, may include a separation reservoir 102, a first electric field generator 204, a second electric field generator 206 and a plurality of sensing elements 108. The separation reservoir 102 may be configured to contain a plurality of target molecules. The first electric field generator 204 may be configured to provide a first electric field across the separation reservoir 102. The first electric field may have a first direction. The second electric field generator 206 may be configured to provide a second electric field across the separation reservoir 102. The second electric field may have a second direction. The second direction may be at least substantially perpendicular to the first direction. The plurality of sensing elements 108 may be arranged on a side of the separation reservoir 102. The plurality of sensing elements 108 may be positioned on the first side of the separation reservoir 102. Each sensing element 108 within the plurality of sensing elements 108 may be configured to detect target molecules within a vicinity of the respective sensing element 108. The plurality of sensing elements 108 may be electrochemical sensors. The plurality of sensing elements 108 may be optical sensors such as biophotonic sensors.

In addition, the sensor device 200 may include an ionic chamber 210, a plurality of channels 212, a plurality of valves 214, a controller 216, a reference electrode 222 and a counter electrode 224. The first electric field generator 204 may include a set of separation electrodes which includes at least one separation electrode. The set of separation electrodes may include a first separation electrode 218A and a second separation electrode 218B, which may be positioned at a first end of the separation reservoir 102 and a second end of the separation reservoir 102, respectively. The second end of the separation reservoir 102 may oppose the first end of the separation reservoir 102. At least one of the first separation electrode 218A or the second separation electrode 218B may have a width at least substantially equal to the width of the separation reservoir 102. The width of the separation reservoir 102 may be at least substantially parallel to the second direction. The second electric field generator 206 may include a set of transfer electrodes which includes at least one transfer electrode. The set of transfer electrodes may include a first transfer electrode 220A and a second transfer electrode 220B, which may be positioned at a first side of the separation reservoir 102 and a second side of the separation reservoir 102, respectively. The second side may oppose the first side. At least one of the first transfer electrode 220 or the second transfer electrode 220B may be positioned within the ionic chamber 210. At least one of the first transfer electrode 220A or the second transfer electrode 220B may have a length at least substantially equal to a length of the separation reservoir 102. The length of the separation reservoir 102 may be at least substantially parallel to the first direction. At least one of the reference electrode 222 or the counter electrode 224 may be positioned beside the plurality of sensing elements 108.

The plurality of channels 212 may be positioned between the separation reservoir 102 and the plurality of sensing elements 108. Each channel of the plurality of channels 212 may have a first opening facing the separating reservoir 102 and a second opening facing a respective sensing element 108. Each valve 214 of the plurality of valves 214 may be configured to block a respective channel 212 of the plurality of channels 212 when the second electric field generator 206 is activated. The ionic chamber 210 may be positioned on one side of the separating reservoir 102, for holding an ionic buffer. The ionic chamber 210 may be positioned on the second side of the separation reservoir 102.

The controller 216 may be configured to control a sequence of activation of the first electric field generator 204, the second electric field generator 206 and the plurality of sensing elements 108. The sequence of activation may start with the first electric field generator 204, followed by the second electric field generator 206 and further followed by the plurality of sensing elements 108. The controller 216 may be configured to activate the second electric field generator 206 after deactivating the first electric field generator 204. The controller 216 may also be configured to activate the plurality of sensing elements 108 after deactivating the second electric field generator 206. The separation reservoir 102, the first electric field generator 204, the second electric field generator 206, the ionic chamber 210, the controller 216, the reference electrode 222, the counter electrode 224, the plurality of channels 212, the plurality of valves 214 and the plurality of sensing elements 108 may be connected to each other via a connection 226. The connection 226 may be at least one of a mechanical or an electrical connection.

FIG. 3 shows a flow diagram 300 showing a method of operating a sensor device in accordance to various embodiments. In 330, a separation reservoir configured to contain a plurality of target molecules, may be provided. In 332, a first electric field may be provided across the separation reservoir, using a first electric field generator. The first electric field may have a first direction. In 334, a second electric field may be provided across the separation reservoir, using a second electric field generator. The second electric field may have a second direction, which may be at least substantially perpendicular to the first direction. In 336, a plurality of sensing elements may be provided. The plurality of sensing elements may be arranged on a side of the separation reservoir. In 338, the plurality of target molecules may be detected within a vicinity of each sensing element of the plurality of sensing elements. The method may further include controlling a sequence of activating the first electric field generator, second electric field generator and the plurality of sensing elements. The sequence of activation may be the first electric field generator, followed by the second electric field generator, followed by the plurality of sensing elements. The second electric field generator may be activated after deactivation of the first electric field. The plurality of sensing elements may be activated after deactivation of the second electric field generator.

A sensor device in accordance to various embodiments may have sensing electrodes directly integrated into an electrophoresis separating matrix, to efficiently reduce the effect of background interference and to enhance the target signal sensitivity. The sensor device may separate bio-molecules according to at least one of their molecule sizes or charges, using electrophoresis. A plurality of sensing electrodes may be placed restrictedly and locally at a respective plurality of locations corresponding to their respective target molecule positions. The separated bio-molecules may be pulled towards their respective sensing electrodes, which then detect the respective bio-molecules to provide detection signals. With this method, the detection signals provided by a sensor electrode refers purely to the population of molecules that are adsorbed or in a close proximity to the sensor electrode. The detection at a sensor electrode may not be affected by the population of other types of molecules located at other positions. Therefore, highly sensitive and specific signal detections may be achieved. By having multiple sensor electrodes positioned at different target molecule positions, the biosensor may also achieve multiplex signal detection. Therefore, a biosensor in accordance to various embodiments may provide a label-free method for multiplex signal detection with high sensitivity and specificity. A sensor device in accordance to various embodiments may be utilized as a platform for POC applications.

A sensor device or biosensor platform, in accordance to various embodiments, may be able to reduce the effect of background interference, enhance detection sensitivity and specificity, and perform multiplex signal detection. The sensor device may have sensor electrodes integrated directly onto an electrophoresis separating matrix. Each sensor electrode may be placed locally at a specific target molecule position to enhance detection specificity, so that other background molecules which are not located within a close proximity to the sensor electrode may not interfere with the target signal. The pulling of the separated target molecule towards the sensor electrode enriches the sensor surface with the target molecules, thereby enhancing the detection sensitivity of the sensor electrode. Integration of multiple sensor electrodes at different positions along the separating matrix allows simultaneous detection of different target molecules. Altogether, the unique properties of the sensor device benefits developments in the biosensor field and fulfill all the requirements of POC applications.

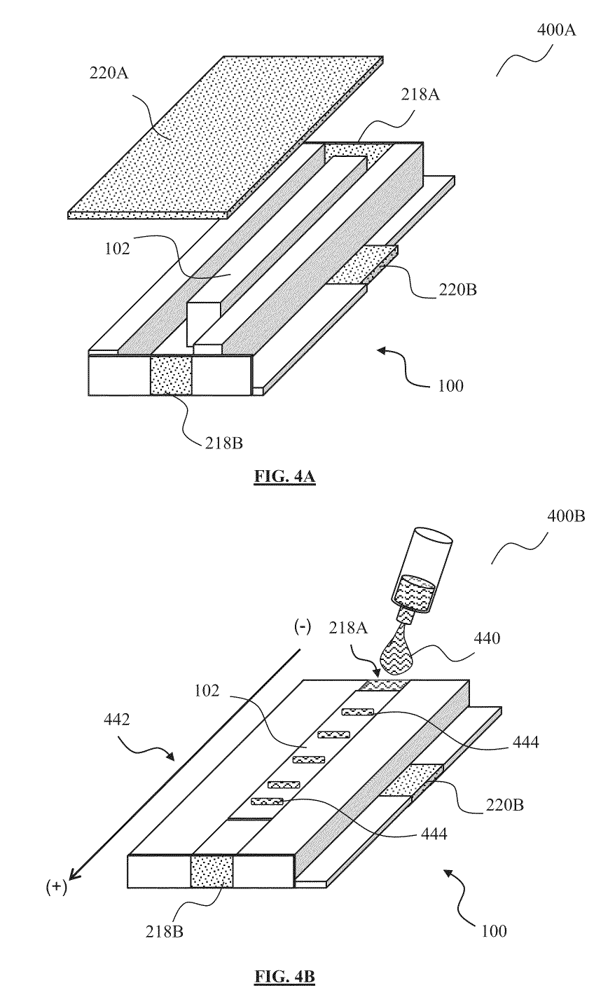

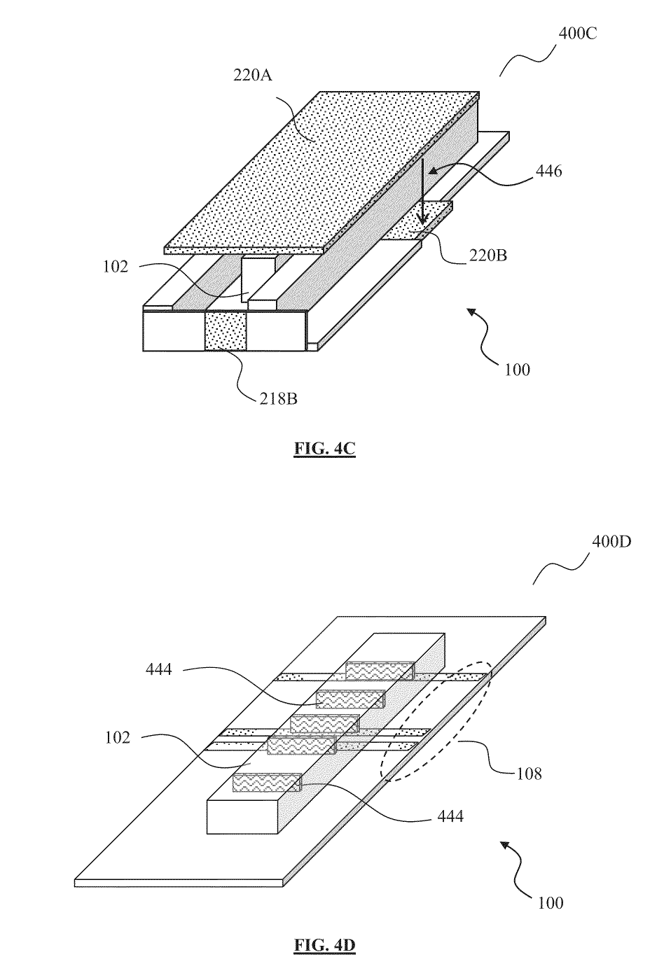

FIG. 4A to 4D show a method of operating a sensor device 100 in accordance to various embodiments. FIG. 4A shows a partially exploded view 400A of the sensor device 100. The sensor device 100 may include a separation reservoir 102 and four electrodes positioned at a front, back, top and bottom of the separation reservoir 102. The electrodes at the front and back of the separation reservoir 102 may be a first separation electrode 218A and a second separation electrode 218B, respectively. The electrode at the top of the separation reservoir 102 may be a first transfer electrode 220A. The electrode at the bottom of the separation reservoir 102 may be a second transfer electrode 220B. The sensor device 100 may also include a plurality of sensing elements, which may be sensing electrodes.

FIG. 4B shows a perspective view 400B of a portion of the sensor device 100 of FIG. 4A. The separation reservoir 102 may be filled with a separation matrix loaded with a sample 440 to be analysed. The sample 440 may include a plurality of target molecules. The plurality of target molecules may be biomolecules, such as proteins. An electrical signal may be applied to the first separation electrode 218A and the second separation electrode 218B, to provide a first electric field across the separation reservoir 102. The first electric field may have a first direction 442. The length of the separating reservoir 102 may be parallel to the first direction 442. The target molecules within the separation matrix may be separated under the effect of the first electric field, in other words, through the process of electrophoresis. As shown in FIG. 4B, under the effect of the first electric field, the sample 440 may be separated into separated samples 444 in the separation reservoir 102.

FIG. 4C shows a perspective view 400C of the sensor device 100 of FIG. 4A. After the plurality of target molecules have been separated, an electric signal may be applied to the top electrode and the bottom electrode, which may be the first transfer electrode 220A and the second transfer electrode 220B, respectively. A second electric field having a second direction 446, may be formed in between the top electrode and the bottom electrode. The plurality of separated samples, each separated sample containing one type of target molecules, may be pulled down by the second electric field.

FIG. 4D shows a perspective view 400D of a portion of the sensor device 100 of FIG. 4A. Sensing elements 108 may be integrated directly onto the separating reservoir 102, so that the pulled down plurality of separated target molecules may adsorb onto the sensing elements 108 or come to a close proximity of the sensing elements 108. The sensing elements 108 may detect signals resulting from the adsorbed target molecules or the target molecules in a vicinity of the sensing elements 108. The sensing elements 108 may be placed at various positions along the separation reservoir 102, such that the various positions correspond to the positions of the plurality of separated target molecules. The sensing elements 108 may be positioned restrictedly and locally at the target molecule positions so that the signals detected refer solely to the population of molecules at the respective sensing element 108 regardless of the presence of background molecules at other positions in the separation reservoir 102. As a result, the sensor device 100 may be able achieve enhanced detection specificity. By positioning the plurality of sensing elements 108 at different positions along the separation reservoir 102, the sensor device 100 may be able to achieve multiplex signal detection, as each sensing element 108 is able to function independently of the other sensing elements 108.

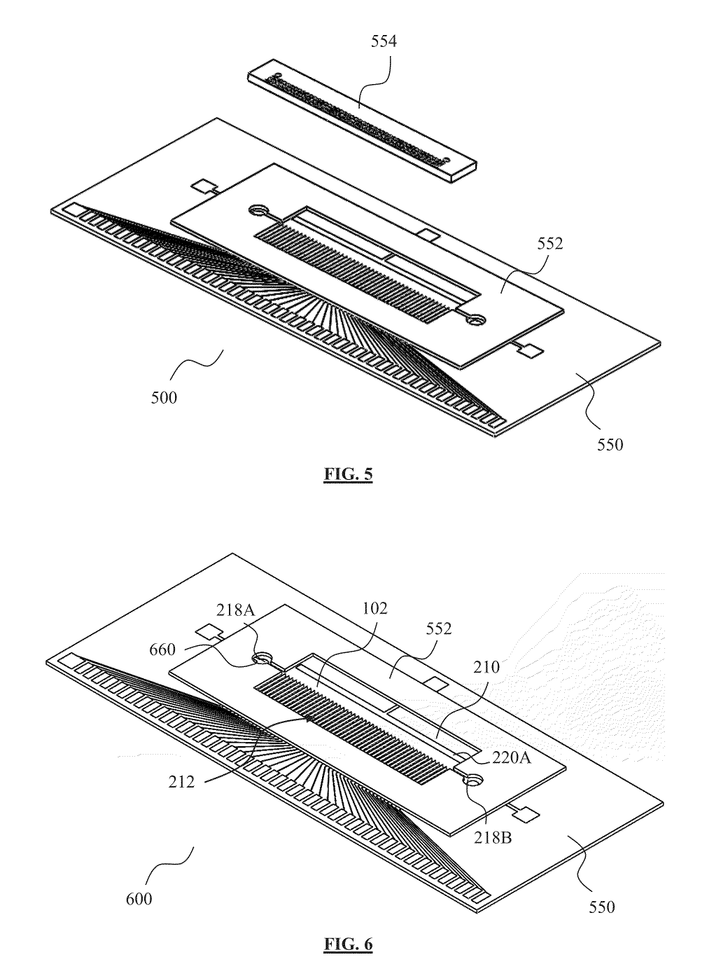

FIG. 5 shows a perspective view 500 of a sensor device in accordance to various embodiments. The sensor device may be a microfluidic device including an electrode layer 550, a microfluidic layer 552 and a valve layer 554. The electrode layer 550 may include a first electric field generator, a second electric field generator and a plurality of sensing elements. The microfluidic layer 552 may include a separation reservoir, an ionic chamber and a plurality of channels. A sample containing a plurality of target molecules may be loaded into a separation matrix contained within the separation reservoir. The valve layer 554 may include a plurality of valves which may be pneumatic valves. The electrode layer 550 may be the bottommost layer. The microfluidic layer 552 may be placed above the electrode layer 550. The valve layer 554 may be the topmost layer, placed above the microfluidic layer 552, so that the plurality of valves may be positioned above the plurality of channels.

FIG. 6 shows a perspective view 600 of the sensor device of FIG. 5. The first electric field generator may include a first separation electrode 218A positioned at a first end of the separation reservoir 102 and a second separation electrode 218B positioned at a second end of the separation reservoir 102, wherein the second end opposes the first end. At least one of the first separation electrode 218A or the second separation electrode 218B may be at least as wide as a width of the separation reservoir 102. The width of the separation reservoir 102 may be defined as at least substantially perpendicular to a length of the separation reservoir 102, the length of the separation reservoir 102 being defined as a distance between the first end and the second end. The second electric field generator may include a first transfer electrode 220A positioned at a first side of the separation reservoir and a second transfer electrode 220B positioned at a second side of the separation reservoir (hidden from view in FIG. 6), wherein the second side opposes the first side. At least one of the first transfer electrode 220A or the second transfer electrode 220B may be at least as long as the length of the separation reservoir 102.

The microfluidic layer 552 may include a separation reservoir 102, an ionic chamber 210 and a plurality of channels 212. The plurality of channels 212 may be a plurality of microchannels. The plurality of channels 212 may be introduced in between the separation reservoir 102 and the plurality of sensing elements. The plurality of channels 212 may provide additional storage of ionic buffer to promote efficient sample transfer out of the separation matrix. The plurality of channels 212 may be arranged as an array of channels placed along one longitudinal side, in other words, one of the first side or the second side of the separating reservoir 102. Each channel 212 of the plurality of channels 212 may be arranged perpendicularly to the separation reservoir 102 such that a first opening of the channel 212 is facing the separation reservoir 102. Each channel 212 may have a second opening facing a respective sensing element. An ionic chamber 210 may be introduced on the opposite site of the array of channels 212, across the separation reservoir 102, to serve as a further reservoir for storing ionic buffer. The ionic chamber 210 may have an opening facing the separation reservoir 102. The separation reservoir 102 may separate the ionic chamber 210 from the plurality of microchannels 212. The additional ionic buffer stored within the ionic chamber 210 promotes efficient sample transfer out of the separation matrix, as the ionic buffer provides extra ionic field outside of the separating matrix which drives the target sample to exit the matrix into the buffer storage at the second transfer electrode 220B, under the influence of the second electric field.

The sensor device may further include a loading chamber 660 at one of a first end or a second end of the separation reservoir 102. The loading chamber 660 may be configured for loading of a sample into the separation matrix contained within the separation reservoir 102.

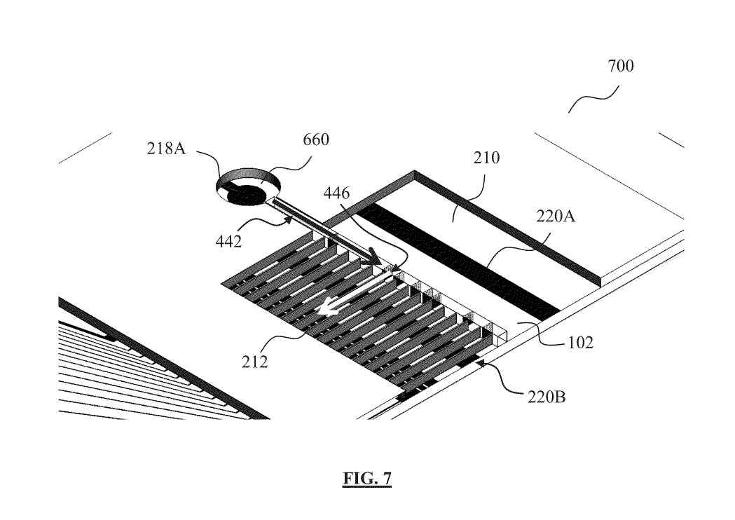

FIG. 7 shows an enlarged view 700, of the sensor device of FIG. 5, for illustrating an operation process of the sensor device. A sample containing a plurality of target molecules may be loaded into the loading chamber 660. The loading chamber 660 may have at least one opening facing the separation reservoir 102, so that the sample may flow into the separation reservoir 102. The separation reservoir 102 may be filled with a separation matrix, such as a gel matrix. The separation matrix may serve as a sieving medium during electrophoresis, retarding the passage of molecules so that the difference in movement speed of different types of molecules becomes more pronounced.

After the sample is loaded into the loading chamber 660 or the separation reservoir 102, the first electric field having the first direction 442, may be generated to separate the plurality of target molecules through electrophoresis. Electrophoresis is a technique for separating molecules based on at least one of their size or electrical charge. During electrophoresis, an electrical field may be applied so that the target molecules move towards or away from a direction of the electrical field. The first electric field may be generated by applying a voltage to the first separation electrode 218A and the second separation electrode 218B. Under the influence of the first electric field, the sample separates out into a plurality of smaller portions, each portion carrying a type of target molecules. When the plurality of target molecules have separated out to different positions along the separation reservoir 102, the first separation electrode 218A and the second separation electrode 218B may be deactivated. The second electric field having the second direction 446 may then be generated to transfer the plurality of target molecules from the separation reservoir 102 into the plurality of channels 212. The second direction 446 may be at least substantially perpendicular to the first direction 442. The second electric field may be generated by applying a voltage to the first transfer electrode 220A and the second transfer electrode 220B. The second transfer electrode 220B may be positioned under the plurality of channels 212. As the plurality of target molecules have been separated out to different positions along the separation reservoir 102 prior to activation of the first transfer electrode 220A and the second transfer electrode 220B, the second electric field pulls the plurality of target molecules into their respective channels 212 such that each channel 212 may contain one type of target molecules. After the plurality of target molecules have been moved into the plurality of channels 212, the first transfer electrode 220A and the second transfer electrode 220B may be deactivated. Each channel may have at least one sensing element located at an end opposing the separation reservoir 102. The sensing elements may then be activated, to detect the target molecules within the respective channels 212.

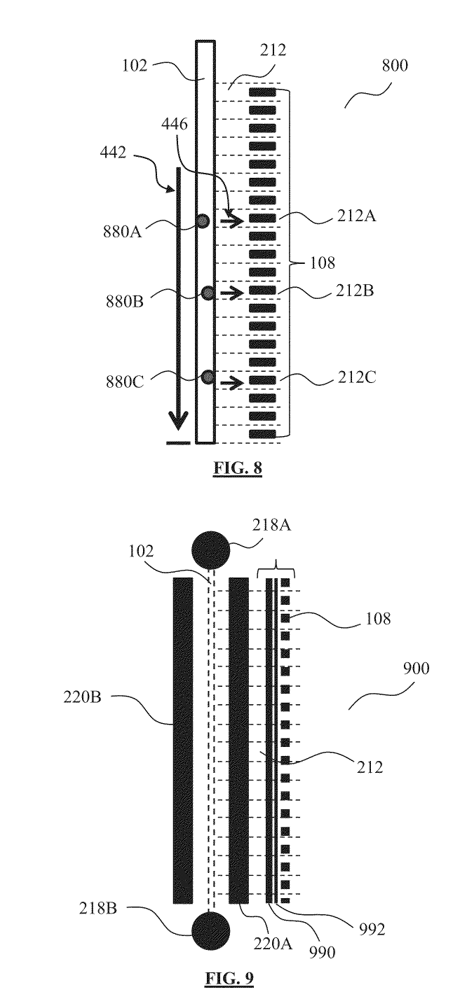

FIG. 8 shows a top view 800 of a plurality of channels 212 of a sensor device in accordance to various embodiments. The plurality of channels 212 may be arranged as a channel array. The channel array may be positioned at least substantially parallel to a separation reservoir 102, with each channel 212 within the channel array being arranged at least substantially perpendicular to the separation reservoir 102. Each channel 212 may have a first opening facing the separation reservoir 102 and a second opening facing a sensing element 108. Each sensing element 108 may also be located within a channel 212. A plurality of target molecules may be separated by a first electric field having a first direction 442. For example, a sample containing Target A, Target B and Target C may be loaded into the sensor device. On activation of a first electric field generator, the sample may be separated by the first electric field, into three distinct groups of Target A molecules 880A, Target B molecules 880B and Target C molecules 880C. Each group may have moved through a different distance, so each group may be located at a different position along a length of the separation reservoir 102. On activation of a second electric field generator, a second electric field having a second direction 446 may be provided. The three distinct groups may move along the second direction 446, into three different channels 212A, 212B and 212C. The sensing element 108 in the channel 212A, the sensing element 108 in the channel 212B and the sensing element 108 in the channel 212C may each provide a detection signal, the detection signal containing information on the molecules within the respective channels 212A, 212B and 212C.

FIG. 9 shows a top view 900 of a sensor device in accordance to various embodiments. The sensor device may include a first separation electrode 218A, a second separation electrode 218B, a first transfer electrode 220A, a second transfer electrode 220B, a separation reservoir 102, a plurality of channels 212 and a plurality of sensing elements 108. The sensor device having electrochemical sensors as the plurality of sensing elements 108 may further include a reference electrode 990 and a counter electrode 992. The reference electrode 990 and the counter electrode 992 may be positioned serially to the first transfer electrode 220A or the second transfer electrode 220B. The reference electrode 990 and the counter electrode 992 may be positioned at least substantially parallel to a sensor array which includes the plurality of sensing elements 108. The reference electrode 990 and the counter electrode 992 may be similar in length as the separation reservoir 102 or one of the first transfer electrode 220A or the second transfer electrode 220B. The length of the separation reservoir 102 may be defined as a distance between two ends of the separation reservoir 102, the distance being at least substantially parallel to a distance between the first separation electrode 218A and the second separation electrode 218B. The reference electrode 990 and the counter electrode 992 may also be similar in length as the sensor array.

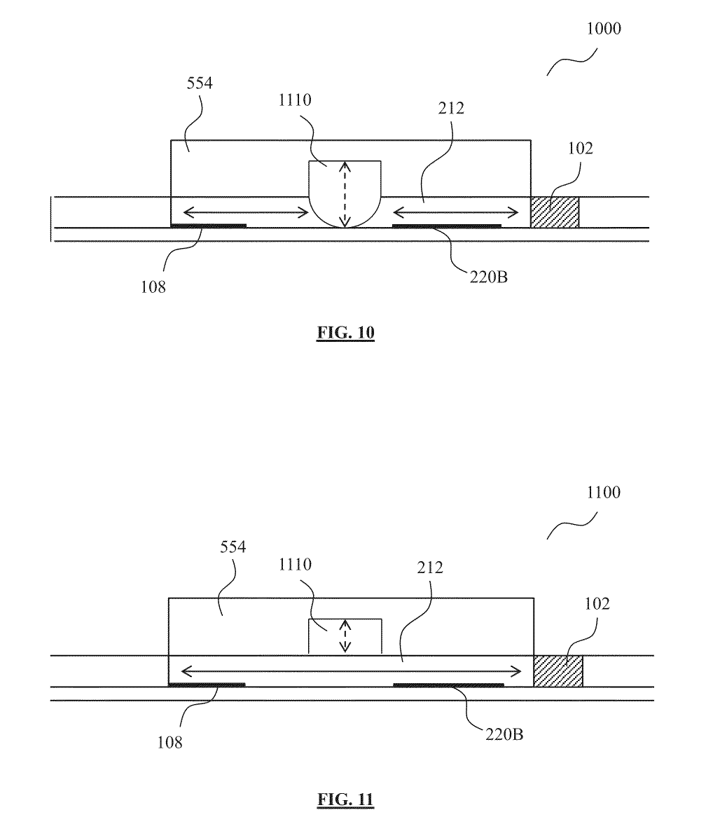

FIG. 10 shows a cross-sectional view 1000 across a channel 212 of a sensor device in accordance to various embodiments. The sensor device may include a separation reservoir 102, a first electric field generator, a second electric field generator, a valve layer 554, a plurality of channels 212 and a plurality of sensing elements 108. The second field generator may include a first transfer electrode 220A and a second transfer electrode 220B. The second transfer electrode 220B may lie within the channel 212. The valve layer 554 may include a plurality of valves 1110 and the valve layer 554 may be positioned over the plurality of channels 212 so that there may be one valve 1110 above each channel 212. The valve 1110 may be a pneumatic valve which may be inflatable with at least one of a gas or a liquid. There may be one sensing element 108 placed at one end of each channel 212. During electrophoresis, a strong electrical field may be generated in the sensor device. The sensing elements 108 may be surface modified sensors, which may have the surface chemistry of their surfaces potentially destroyed by the strong electrical field. The valves 1110, when inflated, may separate the sensing elements 108 from the high electrical field during electrophoresis, or when any one of the first electric field generator or the second electric field generator is being operated. When any one of the first electric field generator or the second electric field generator is activated, the valve 1110 may be inflated or expanded to block ionic buffer or electrically charged particles from flowing towards the sensing element 108. When the valve 1110 is expanded, it may partition the channel 212 into two compartments, limiting ionic flow from contacting the sensing element 108. The valve 1110 when expanded, may isolate the sensing element 108 in a first compartment, separate from the second transfer electrode 220B in a second compartment.

FIG. 11 shows a cross-sectional view 1100 of the sensor device of FIG. 10. After target molecules are transferred out of the separation reservoir 102, into the channels 212, the valve 1110 may be released to its resting state so that the target molecules may move towards the sensing elements 108 located at an end of the channel 212, for signal detection. The resting state of the valve 1110 may allow ionic buffer to flow freely within the channel 212, connecting ionic buffer of a transfer electrode to the sensing element 108.

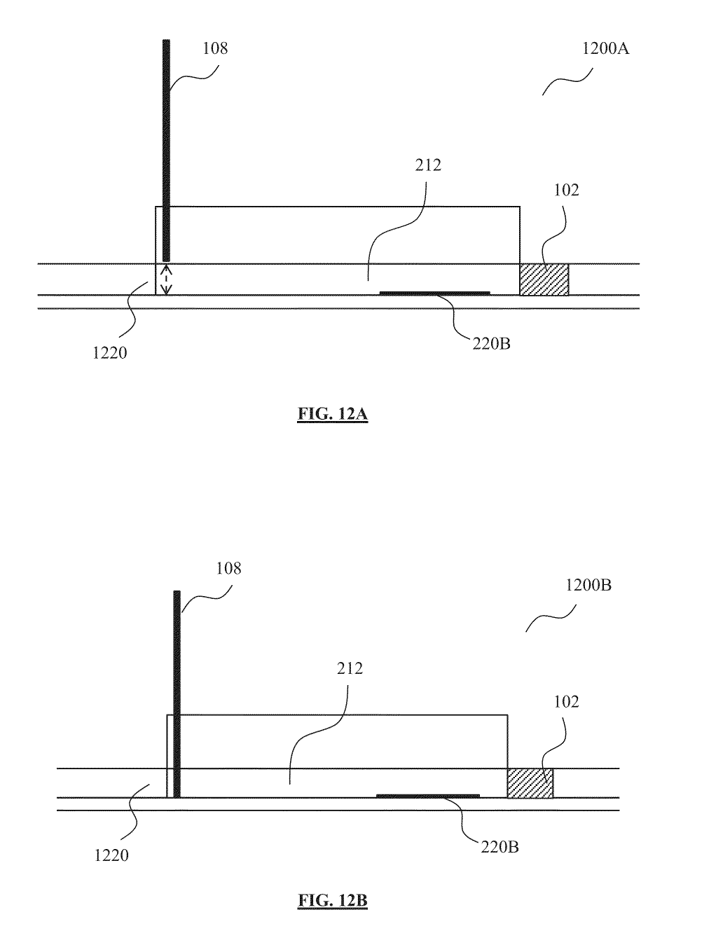

FIG. 12A shows a cross-sectional view 1200A across a channel of a sensor device in accordance to various embodiments. The sensor device may be similar to the sensor device of FIG. 10 in that it includes a separation reservoir 102, a first electric field generator, a second electric field generator, a plurality of channels 212 and a plurality of sensing elements 108. The second electric field generator may include a first transfer electrode 220A and a second transfer electrode 220B. The second transfer electrode 220B may lie within the channel 212. A sample containing a plurality of target molecules may be loaded into the separation reservoir 102 of the sensor device. The sensing elements 108 may be detachable or separable from the channels 212 during electrophoresis, to protect the surface chemistry of the sensing elements 108 from the high electrical field generated during electrophoresis. The sensing element 108 may be moveable between a first position inside the channel 212 and a second position outside of the channel 212. The sensing element 108 may be configured to move to the second position when at least one of the first electric field generator or the second electric field generator is activated. The sensing element 108 may be a sensor electrode located outside of the channel 212, for example the sensing element 108 may be located above the channel 212 as shown in 1200A, during operation of one of the first electric field generator or the second electric field generator.

FIG. 12B shows a cross-sectional view 1200B of the sensor device of FIG. 12A. After target molecules are transferred out of the separation reservoir 102 into the plurality of channels 212, the sensing element 108 in each channel 212 may be moved downwards into the first position, which is inside the channel 212, for measurement of signals from the target molecules. The sensing element 108 may be moved into the first position only when the second electric field generator is deactivated. Alternatively, the sensing element 108 may be located on the same plane as the channel 212, for example the sensing element 108 may placed serially to the channel 212 at area 1220 during electrophoresis and moved into the channel 212 after deactivation of the first electric field generator and the second electric field generator, so that the sensing element 108 may perform detection of the target molecules within the channel 212. By having moveable sensing elements 108, the surface chemistry of the sensing elements 108 may be preserved, so that the sensing elements 108 may remain sensitive for identification of the target molecules.

In the following, experiments of sensor devices according to various embodiments will be described.

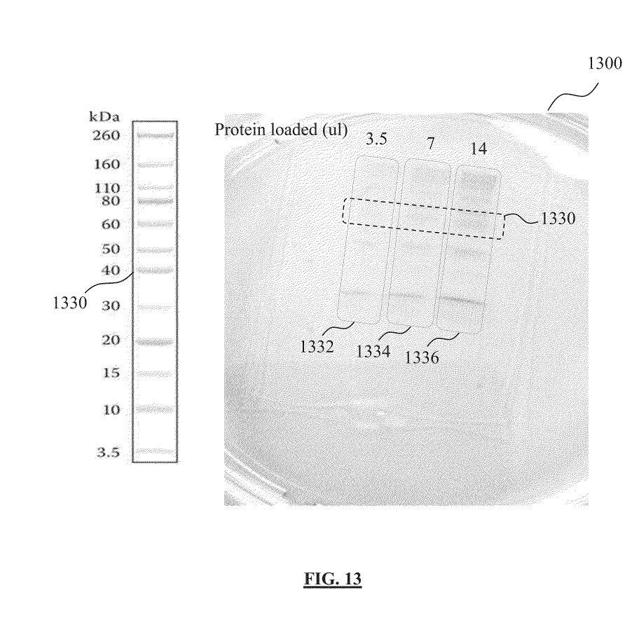

FIG. 13 is a photograph 1300, showing separation of a plurality of proteins, from three samples containing different amounts of proteins. A first sample 1332 containing 3.5 μl of proteins, a second sample 1334 containing 7 μl of proteins and a third sample 1336 containing 14 μl of proteins were each loaded into a sodium dodecyl sulfate (SDS) polyacrylamide gel and separated into their constituents proteins through sodium dodecyl sulfate polyacrylamide gel electrophoresis (SDS-PAGE), according to their molecular mass. 40 kDa proteins 1330 are proteins that have a molecular weight of 40 kDa. The 40 kDa proteins 1330 of each of the first sample 1332, the second sample 1334 and the third sample 1336 were incised out of the SDS polyacrylamide gel. The 40 kDa proteins 1330 were then placed in a test set-up for validating the feasibility of signal detection using a sensor device according to various embodiments. Two types of sensor electrodes, namely an electrochemical sensor and a biophotonic sensor, were used as the sensing elements of the sensor device, in the experiments.

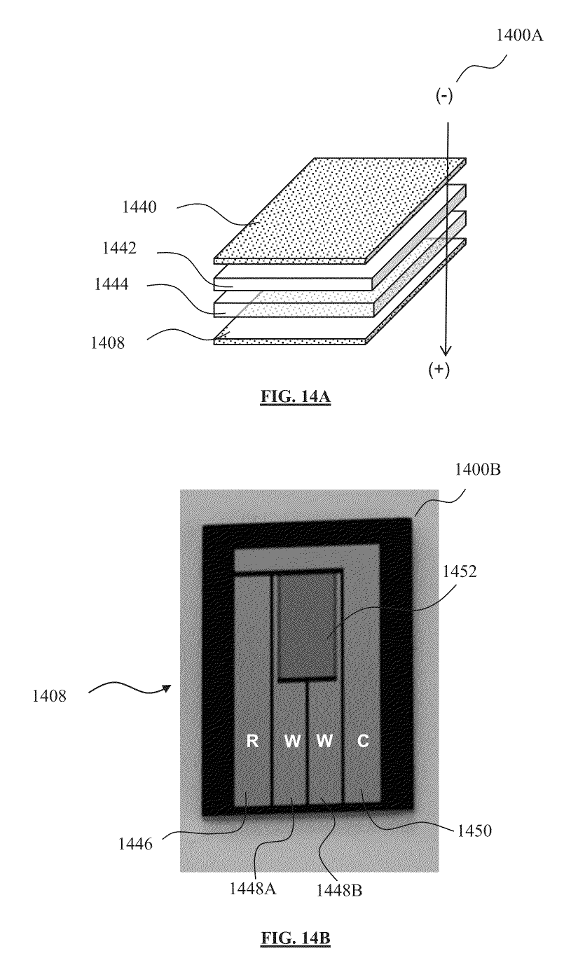

FIG. 14A shows a schematic diagram of the set-up 1400A of the experiment described above, using an electrochemical sensor as the sensing element. The set-up 1400A includes a blank gold chip 1440, a layer of paper 1442, a gel layer 1444 and an electrochemical sensor 1408, arranged in a descending order with the blank gold chip 1440 as the topmost layer and the electrochemical sensor 1408 as the bottommost layer. The blank gold chip 1440 functions as a top electrode while the electrochemical sensor 1408 functions as both a sensing element as well as a bottom electrode. Proteins were loaded in the gel layer 1444, which was placed under the blank gold chip 1440 and above the electrochemical sensor 1408. The proteins were pulled down onto the electrochemical sensor 1408 by an electric field generated between the blank gold chip 1440 and the electrochemical sensor 1408 when an electrical signal was applied to the blank gold chip 1440 and the electrochemical sensor 1408. After the proteins were pulled down onto the electrochemical sensor 1408, the electrochemical sensor generates output signals based on its detection of the proteins. The output signals were then analyzed using the electrochemical impedance spectroscopy (EIS) technique.

FIG. 14B shows a top view 1400B of the electrochemical sensor 1408 used in the test set-up 1400A of FIG. 14A. The electrochemical sensor 1408 includes a reference electrode 1446, a first working electrode 1448A, a second working electrode 1448B and a counter electrode 1450. Each working electrode includes a comb structure. The comb structure of the first working electrode 1448A and the comb structure of the second electrode 1448B are arranged in an interdigitated fashion where comb teeth from each working electrode are placed in between each other, to form an interdigitated comb structure 1452.

FIG. 15 shows a graph 1500 having a vertical axis 1550 and a horizontal axis 1552. The graph 1500 is plotted using the output signals obtained from the experiment described above. The vertical axis 1550 indicates the imaginary component of the impedance while the horizontal axis 1552 indicates the real component of the impedance. The graph 1500 also includes a first line 1554, a second line 1556, a third line 1558 and a fourth line 1560. The first line 1554 represents the impedance values of a control sample, which does not contain any proteins. The second line 1556, the third line 1558 and the fourth line 1560 represent the impedance values obtained for a gel containing 3.5 μl of proteins, 7 μl of proteins and 14 μl of proteins, respectively. As shown in the graph 1500, the impedance increases as the amount of proteins increases.

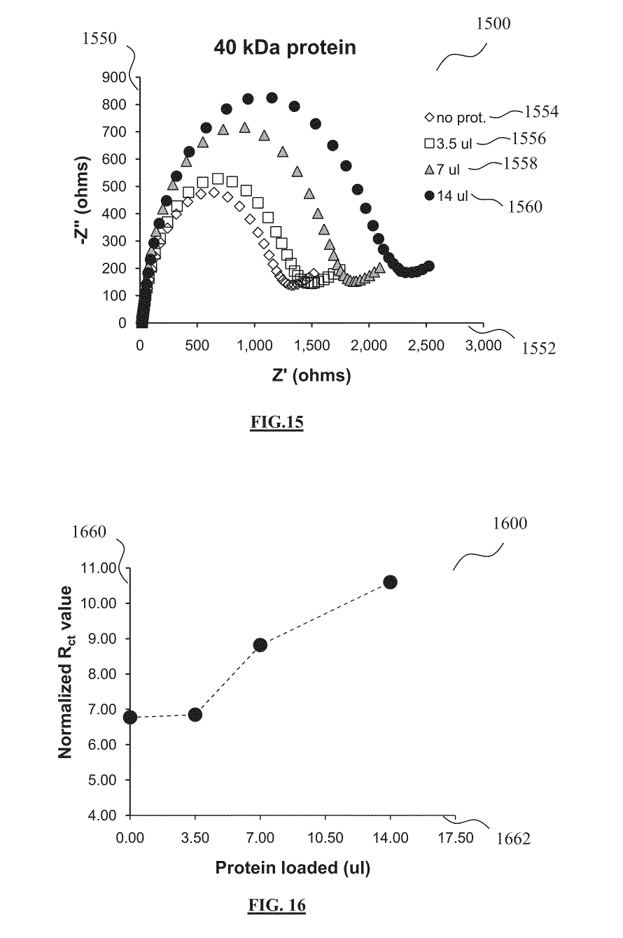

FIG. 16 shows a graph 1600 having a vertical axis 1660 and a horizontal axis 1662. The graph 1600 is plotted using the output signals obtained from the experiment described above. The vertical axis 1660 indicates the normalized charge transfer value (Rct) while the horizontal axis 1662 indicates the amount of proteins in the sample. As shown in the graph 1600, the charge transfer value increases as the amount of proteins increase.

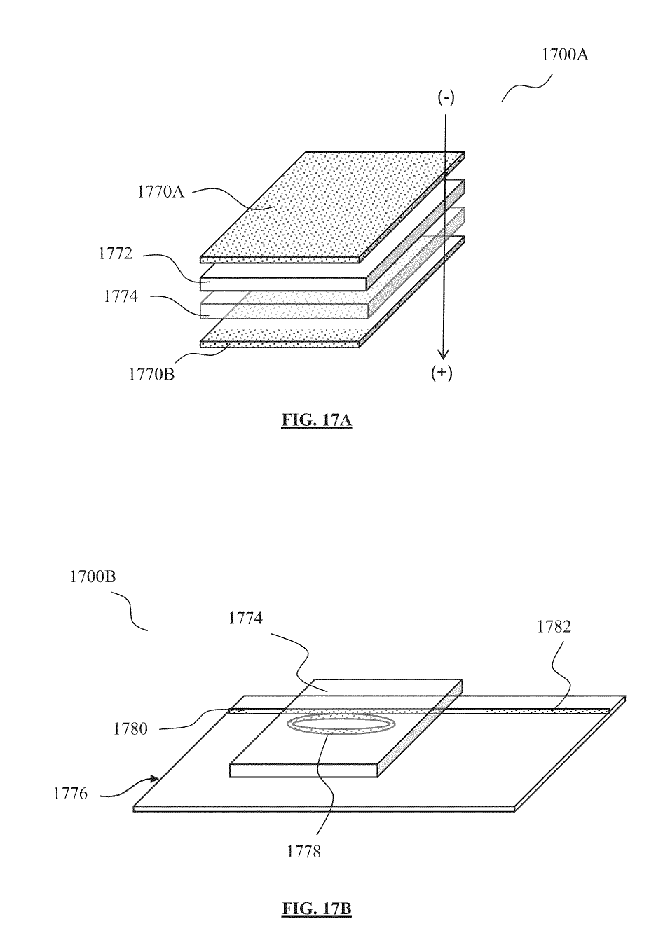

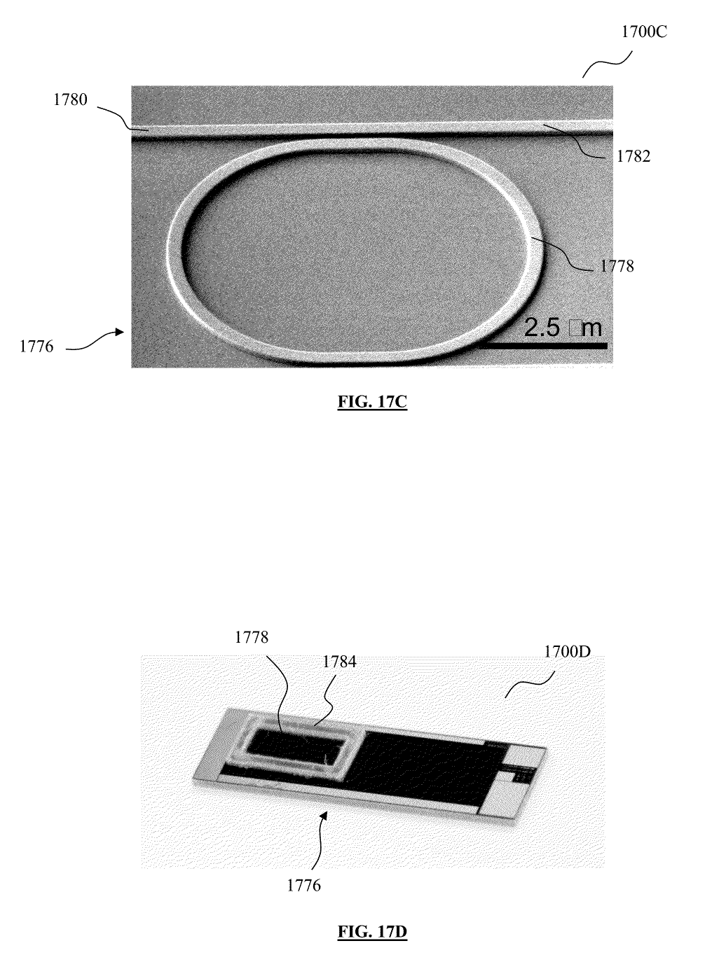

FIG. 17A shows a schematic diagram of a test set-up 1700A for an experiment to validate the feasibility of a sensor device in accordance to various embodiments. The test set-up 1700A uses a biophotonic sensor for the experiment. The test set-up 1700A includes a first blank gold chip 1770A, a layer of paper 1772, a gel layer 1774 and a second blank gold chip 1770B. The gel layer 1774 may be loaded with the 40 kDa protein of FIG. 13. Similar to the test set-up of FIG. 14A, the proteins within the gel layer 1774 are pulled down to a surface of the gel layer, using an electric field generated across the gel layer 1774 by the two blank gold chips located at the top and bottom of the gel.

FIG. 17B shows a schematic diagram 1700B of a biophotonic chip 1776 for detecting proteins pulled down to the surface of the gel layer 1774 of FIG. 17A. The biophotonic chip 1776 may be a silicon microring biophotonic chip having a microring structure 1778. The biophotonic chip 1776 may also include an input waveguide 1780 and an output waveguide 1782. After the proteins are pulled down to the surface of the gel layer 1774 using the test set-up 1700A, the gel layer 1774 is removed from the blank gold chips of the test set-up 1700A and placed on top of the biophotonic chip 1776, such that the sensor surface of the biophotonic chip 1776 is in contact with the surface of the gel layer 1774. After placing the gel layer 1774 over the biophotonic sensor surface, light may be applied to the input waveguide 1780 of the biophotonic chip 1776 to obtain an output signal from the output waveguide 1782 of the biophotonic chip 1776.

FIG. 17C shows a scanning electron microscope (SEM) image 1700C of the silicon micro-ring biophotonic chip 1776 of FIG. 17B. The SEM image 1700C clearly shows the input waveguide 1780, output waveguide 1782 and the microring structure 1778 of the biophotonic chip 1776.

FIG. 17D shows a perspective view 1700D of the biophotonic chip 1776 of FIG. 17B. The biophotonic chip 1776 includes a sensor chamber 1784. The microring structure 1778 is housed within the sensor chamber 1784.

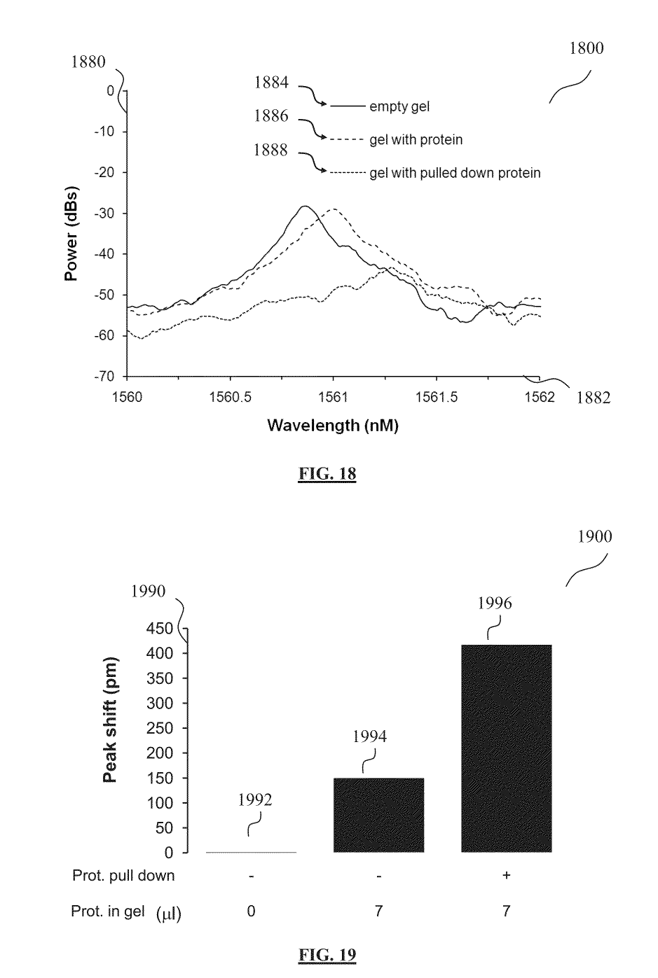

FIG. 18 shows a graph 1800 having a vertical axis 1880 and a horizontal axis 1882. The graph 1800 is plotted using the output signals obtained from the experiment described above, using the biophotonic sensor of FIG. 17B as the sensing element of the sensor device. The vertical axis 1880 indicates the power received by the biophotonic sensor while the horizontal axis 1882 indicates the wavelength of the incident light. The graph 1800 includes a first line 1884 representing a control gel which is void of proteins, a second line 1886 representing a gel loaded with proteins and a third line 1888 representing a gel with pulled down proteins. The gel loaded with proteins has proteins loaded into the gel but the proteins were not pulled down to a surface of the gel. As shown in the graph 1800, both the gel with pulled down proteins 1888 and the gel with proteins 1886 exhibited peak shifts relative to the control gel 1884, in which, the gel with pulled down proteins 1888 experienced a larger peak shift as compared to the gel with proteins 1886.

FIG. 19 shows a bar chart 1900 having a vertical axis 1990. The bar chart 1900 is plotted using the output signals obtained from the experiment described above, using the biophotonic sensor of FIG. 17B as the sensing element of the sensor device. The vertical axis 1990 indicates the peak shift in the refractive index of the sample. The bar chart 1900 includes a first bar 1992, a second bar 1994 and a third bar 1996. The first bar 1992 represents a control sample containing no proteins, the second bar 1994 represents a protein-containing sample which was not exposed to an electric field for pulling the proteins towards the biophotonic sensor while the third bar 1996 represents a protein-containing sample which has its proteins pulled towards the biophotonic sensor. The sample represented by the second bar 1994 and the sample represented by the third bar 1996 each contains 7 μl of proteins. As shown in the graph 1900, the shift in the refractive index increases with an increase in the amount of proteins that come into contact with the biophotonic sensor. Altogether, the results from the experiments using test set-up 1400A and test set-up 1700A confirm the feasibility of obtaining different signals for indicating different amounts of target molecules.

Further experiments were conducted to confirm that a sample loaded into a sensor device in accordance to various embodiments, may be efficiently transferred out of a separation reservoir into a plurality of channels, for example microchannels, and following which, the target signals may be detected.

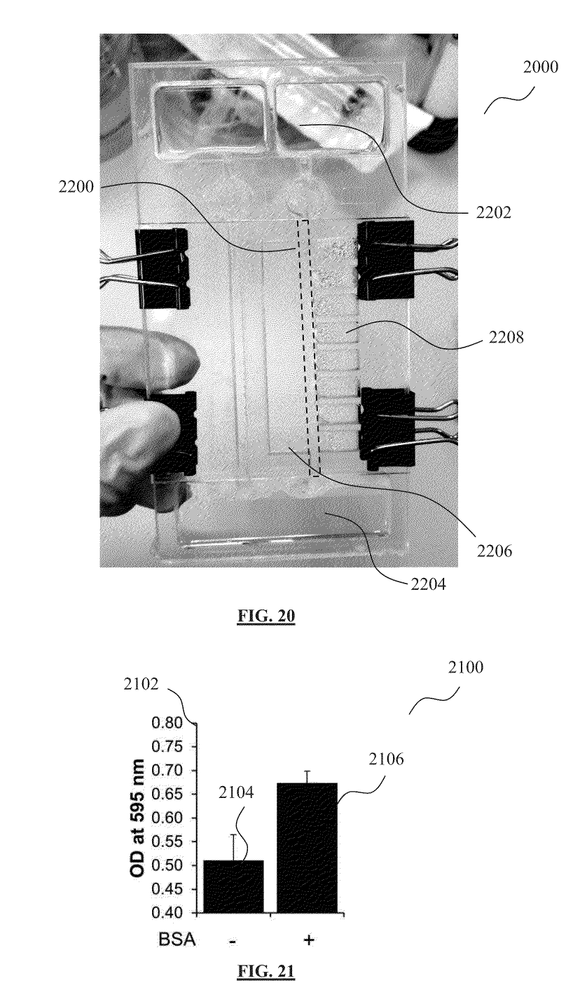

FIG. 20 shows a simple microchannel device 2000 used for the experiment described above. The microchannel device 2000 includes a separation reservoir 2200 loaded with a SDS separating matrix, a first electrode placed at position 2202, a second electrode placed at position 2204, a third electrode placed at position 2206, a fourth electrode placed at position 2208, an ionic chamber at position 2206 and a plurality of microfluidic channels at position 2208. Bovine Serum Albumin (BSA) was used as a sample for the experiment. BSA was mixed with protein ladder and separated through the SDS separating matrix in the separation reservoir 2200, by applying voltage to the first electrode and the second electrode. After the separation process, the BSA was transferred to a microfluidic channel located in line with the BSA molecular weight (66.5 kDa) by applying voltage to the third and fourth electrodes. Empty gel without protein transfer was used as a control. Bradford technique was used to measure the protein concentrations.

FIG. 21 shows a bar chart 2100 having a vertical axis 2102. The vertical axis 2102 indicates the optical density (OD) of the samples measured. The bar chart 2100 has a first bar 2104 representing the optical density of the control and a second bar 2106 representing the optical density of the sample within the microchannel. The higher optical density observed from the second bar 2106 as compared to the first bar 2104 indicates that the BSA was successfully transferred to the microchannel.

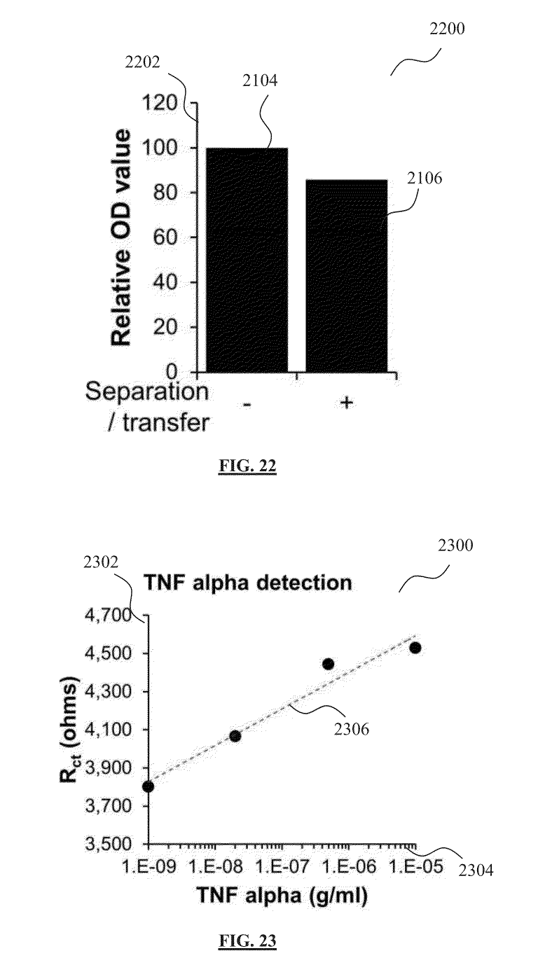

FIG. 22 shows a bar chart 2200 having a vertical axis 2202. The vertical axis 2202 indicates a relative OD value. The bar chart 2200 has a first bar 2104 representing a sample which has not been treated with separation and transfer processes; and a second bar 2106 representing a sample which has been treated with separation and transfer processes. As can be seen from the bar chart 2200, the relative OD value of the second bar 2106 is 85, indicating the efficiency of sample transfer across the separating matrix is about 85%.

FIG. 23 shows a graph 2300 having a vertical axis 2302 and a horizontal axis 2304. The vertical axis 2302 indicated the charge transfer value (Rct) while the horizontal axis 2304 indicated the concentration of the Tumor Necrosis Factor-alpha (TNF-α). The graph 2300 has a line 2306 which was plotted using results obtained from an experiment conducted to determine whether a separated and transferred sample can be detected. The experiment uses TNF-α as the sample and a TNF-α sensor as the sensing element of the sensor device. The TNF-α was mixed with protein ladder and separated through a SDS separating matrix, before being transferred to the microfluidic channel in line with the TNF-α molecular weight (˜17 kDa). The transferred sample was then detected using an EIS-based TNF-α biosensor. As shown by the line 2306, the charge transfer value (Rct) increases upon an increase in TNF-α concentrations with a limit of detection at 1 ng/ml.

The experiments confirmed the feasibility of having microchannels in between an electrophoresis separating matrix and a plurality of sensing elements, for extra storage of ionic reservoir.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced. It will be appreciated that common numerals, used in the relevant drawings, refer to components that serve a similar or the same purpose.

1. A sensor device comprising:
a separation reservoir configured to contain a plurality of target molecules;
a first electric field generator configured to provide a first electric field across the separation reservoir, the first electric field having a first direction;
a second electric field generator configured to provide a second electric field across the separation reservoir, the second electric field having a second direction, wherein the second direction is at least substantially perpendicular to the first direction; and
a plurality of sensing elements arranged on a side of the separation reservoir, wherein each sensing element of the plurality of sensing elements is configured to detect target molecules within a vicinity of the respective sensing element.

2. The sensor device of claim 1, wherein the first electric field generator comprises at least one separation electrode.

3. The sensor device of claim 1, wherein the first electric field generator comprises a first separation electrode positioned at a first end of the separation reservoir and a second separation electrode positioned at a second end of the separation reservoir, wherein the second end opposes the first end.

4. The sensor device of claim 1, wherein the second electric field generator comprises at least one transfer electrode.

5. The sensor device of claim 1, wherein the second electric field generator comprises a first transfer electrode positioned at a first side of the separation reservoir and a second transfer electrode positioned at a second side of the separation reservoir, wherein the second side opposes the first side.

6. The sensor device of claim 1, wherein the first electric field is configured to separate the plurality of target molecules.

7. The sensor device of claim 1, wherein the second electric field is configured to move the plurality of target molecules towards the plurality of sensing elements.

8. The sensor device of claim 1, wherein the plurality of sensing elements are detachable from the sensor device.

9. The sensor device of claim 1, configured as a microfluidic chip.

10. The sensor device of claim 1, further comprising
a plurality of channels positioned between the separation reservoir and the plurality of sensing elements,
wherein each channel of the plurality of channels has a first opening facing the separation reservoir and a second opening facing a respective sensing element.

11. The sensor device of claim 10, further comprising a plurality of valves, each valve of the plurality of valves being configured to block a respective channel of the plurality of channels when the second electric field generator is activated.

12. The sensor device of claim 11, wherein each valve of the plurality of valves is inflatable for blocking the channel.

13. The sensor device of claim 10, wherein each sensing element of the plurality of sensing elements is moveable between a first position and a second position, wherein the first position is inside the respective channel and the second position is outside of the respective channel.

14. The sensor device of claim 13, wherein each sensing element is configured to move to the second position when the second electric field generator is activated.

15. The sensor device of claim 1, further comprising an ionic chamber on one side of the separation reservoir, wherein the ionic chamber is configured to hold an ionic buffer.

16. The sensor device of claim 1, further comprising a controller configured to control a sequence of activation of the first electric field generator, the second electric field generator and the plurality of sensing elements.

17. The sensor device of claim 16, wherein the sequence of activation is the first electric field generator, followed by the second electric field generator, followed by the plurality of sensing elements.

18. The sensor device of claim 16, wherein the controller is configured to activate the second electric field generator after deactivating the first electric field generator.

19. The sensor device of claim 16, wherein the controller is configured to activate the plurality of sensing elements after deactivating the second electric field generator.

20. A method of operating a sensor device, the method comprising:
providing a separation reservoir, the separation reservoir configured to contain a plurality of target molecules;
providing a first electric field across the separation reservoir using a first electric field generator, wherein the first electric field has a first direction;
providing a second electric field across the separation reservoir using a second electric field generator, wherein the second electric field has a second direction, wherein the second direction is at least substantially perpendicular to the first direction;
providing a plurality of sensing elements arranged on a side of the separation reservoir; and
detecting target molecules within a vicinity of each sensing element of the plurality of sensing elements.
